(19) United States
(12) Patent Application Publication
(10) Pub. No.: US 2012/0251837 A1
(43) Pub. Date: Oct. 4, 2012

(54) INFLAMMABLE MAT BOARD FOR ARCHITECTURE AND METHOD FOR MANUFACTURING THE SAME

(75) Inventor: Sung-Min Na, Namyangju-City (KR)

(73) Assignees: Sung-Min, Namyangju-City, Gyeonggi-do (KR); G & G CO., LTD, Namyangju-si, Gyeonggi-do (KR)

(21) Appl. No.: 13/384,141

(22) PCT Filed: Jan. 14, 2010
(86) PCT No.: PCT/KR2010/000225

§ 371 Date: Jan. 13, 2012

(30) Foreign Application Priority Data
Nov. 10, 2009 (KR) 10-2009-0107809

(51) Int. Cl. B32B 15/02; B23K 11/11; C25D 5/02; B32B 13/02; B32B 5/26; B32B 7/04; B23P 17/06; B32B 15/01

(52) U.S. Cl. 428/594; 219/58; 29/4.51; 428/605; 442/59; 442/229; 442/377; 205/118

(57) ABSTRACT

The present invention relates to an inflammable mat board for an architecture and a method for manufacturing the same, and in particular to a mat board which is characterized in that in an inflammable mat board for architecture, a mat shaped board is manufactured in such a way that a metallic thread made from an iron, a nonferrous metal, a waste can and a waste tin plate, etc. is tangled like a cotton ball in a thin sheet shape, so it is possible to recycle materials, and an inflammability can be enhanced, and a heat insulation effect can be maximized, and a recycling rate can be enhanced in terms of a material management, and the production of wastes can be advantageously minimized, thus contributing a lot to a green growth policy of the world.

### CLAIM OF PRIORITY

This application makes reference to, incorporates the same herein, and claims all benefits accruing under 35 U.S.C. §119 from applications filed in the Korean Intellectual Property Office on 10 Nov. 2009 and there duly assigned Serial No. 10-2009-0107809. Furthermore, this application makes reference to, incorporates the same herein, and claims all benefits accruing under 35 U.S.C. §365(c) of my PCT International application entitled FLAME RETARADANT MAT PLATE MATERIAL FOR CONSTRUCTION, AND PREPARATION METHOD THEREOF filed on 14 Jan. 2010 and duly assigned Serial No. PCT/KR2010/000225.

### TECHNICAL FIELD

The present invention relates to an inflammable mat board for an architecture and a method for manufacturing the same, and in particular to a mat board which is characterized in that in an inflammable mat board for architecture, a mat shaped board is manufactured in such a way that a metallic thread made from an iron, a nonferrous metal, a waste can and a waste tin plate, etc. is tangled like a cotton ball in a thin sheet shape, so it is possible to recycle materials, and an inflammability can be enhanced, and a heat insulation effect can be maximized, and a recycling rate can be enhanced in terms of a material management, and the production of wastes can be advantageously minimized, thus contributing a lot to a green industry growth throughout the world.

### BACKGROUND ART

An inflammable mat board for architecture is generally made from asbestos, glass cotton, etc.

The asbestos is manufactured from ore, the production cost of which is low, and heat insulation and soundproof performance are excellent. So, the asbestos had been widely used since 1960s to 1970s.

The asbestos is generally classified as a top class cancer-causing substance which is produced in the course of demolishment of buildings, so the application of the asbestos is very restricted.

Alternatively, a glass cotton has been used for asbestos, which glass cotton is known as having excellent heat insulation and soundproof effects.

The above-described glass cotton costs a lot in terms of its manufacture, and recycling is impossible. In the course of its application, a worker's finger might be easily hurt with a piece of glass, which results in a lot of problems when in use.

The recycle of glass cotton is almost impossible, and a lot of wastes are produced in the course of demolishment of buildings.

The applicable scope of glass cotton is very limited because it is generally used as a heat insulation material or a soundproof material to be attached to a wall. Since a glass cotton per se does not have a support force enough to stably support a certain frame structure, and it cannot be also applied as a floor material.

### SUMMARY OF THE INVENTION

### Disclosure of Invention

Accordingly, it is an object of the present invention to provide an inflammable mat board for an architecture and a method for manufacturing the same which can overcome the problems in a conventional art in which the price of an inflammable mat board for architecture is high, and recycle is impossible, and a lot of architecture wastes are produced, and its handling is risky.

To achieve the above objects, there is provided an inflammable mat board for an architecture and a method for manufacturing the same in which a mat shaped board is manufactured in such a way that a mat shaped board is manufactured as a metallic thread made from an iron, a nonferrous metal, a waste can and a waste tin plate, etc. is tangled like a cotton ball in a thin sheet shape.

### ADVANTAGEOUS EFFECTS

Therefore, the present invention is characterized in that an inflammable mat bard for architecture according to the present invention is made from a metallic thread from an iron, a nonferrous metal, a waste can, a waste tin plate, etc., so materials can be recycled, and inflammability, soundproof and heat insulation performances are maximized, and a recycling rate in the course of demolishment of buildings can be enhanced, and wastes are produced least, which all contribute to a green growth of the world.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view illustrating an embodiment of the present invention;

FIG. 2 is a perspective view illustrating a protection sheet according to an embodiment of the present invention;

FIGS. 3 and 4 are side views illustrating a side view illustrating a hardening finishing layer according to an embodiment of the present invention;

FIG. 5 is a perspective view illustrating an example that a metal mat is formed in a double layer structure according to an embodiment of the present invention;

FIGS. 6, 7 and 8 are views illustrating an example that a metallic mat is formed in a double layer structure with the aid of a plating engaging part according to an embodiment of the present invention;

FIGS. 9 and 10 are views illustrating an example that a metallic mat is formed in a double layer structure with the aid of a spot welding engaging part according to an embodiment of the present invention;

FIG. 11 is a view illustrating an example that a metallic mat is formed in a double layer structure with the aid of a rivet engaging part according to an embodiment of the present invention;

FIG. 12 is a view illustrating an example that a metallic mat is formed in a double layer structure with the aid of a hardening adhesive engaging part according to an embodiment of the present invention;

FIG. 13 is a view illustrating an example of a single metallic thread-combined hardening adhesive engaging part according to an embodiment of the present invention;

FIG. 14 is a view illustrating an example that a metallic mat is formed in a double layer structure with the aid of a hardening adhesive engaging part, and a hardening adhesive agent is formed of a circular diameter hardening adhesive agent according to an embodiment of the present invention; and

FIG. 15 is a side cross sectional view illustrating a state that a resin is impregnated into the whole portions of a metallic mat according to an embodiment of the present invention.

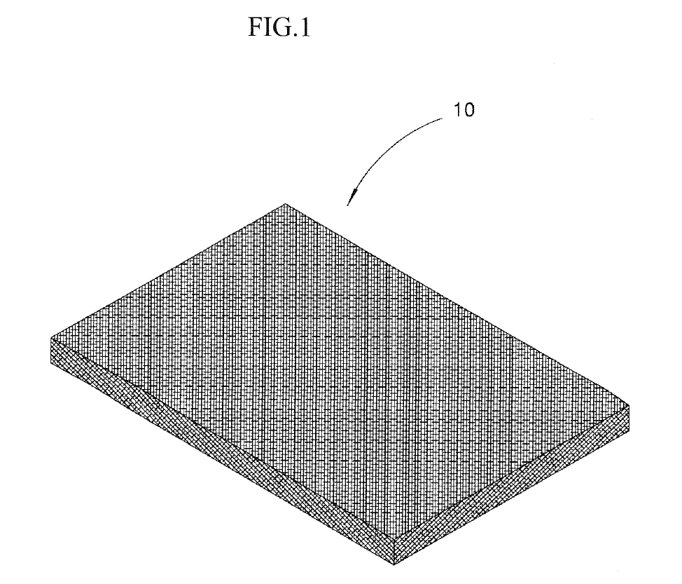

<Descriptions of reference numerals of the drawings>

1: metallic thread

10: metallic mat 11: protection sheet 12: hardening finishing layer

| | |
|---|---|
| 21: plating engaging part | 21a: plating hole |
| 22: stop welding engaging part | 23: rivet engaging part |

24: single metallic thread-combined hardening adhesive engaging part
25: circular diameter hardening adhesive agent

| | |
|---|---|
| 31: plating bathtub | 32: positive electrode |
| 33: negative electrode | 34: plating metal |
| 41: welding port | 42: welding power supplier |
| 43: rotary distributor | |

### DETAILED DESCRIPTION OF THE INVENTION

### Best Modes for Carrying Out the Invention

The preferred embodiment of the present invention will be described with reference to the accompanying drawings.

The present invention is basically directed to enhancing an inflammability and recycling performance in case of an inflammable mat board for architecture.

The inflammable mat board for architecture according to the present invention is characterized in that a metallic mat 10 is formed in such a way that a metallic thread made in a thin shape from an iron, a nonferrous metal, a waste can or a waste thin plate is tangled like a cotton ball or the like.

It is preferred that the metallic thread has 1˜0.1 mm thickness which might help enhance a lightness and a heat insulation performance. It is preferred that an anticorrosion agent such as a zinc and urea resin, an epoxy resin, a cement or a gypsum is coated on an outer surface, thus preventing corrosion.

The coating of the anticorrosion agent is conducted on an outer surface of a metallic thread in the course of the manufacture of a metallic thread or a zinc and urea resin, an epoxy resin, a cement and a gypsum, and an anticorrosion agent is coated in a plating, a spray or an immersion fluid way following the manufacture of a metallic mat 10 with a metallic thread, so the metallic thread forming a metallic mat 10 is coagulated each other for thereby obtaining a durable construction.

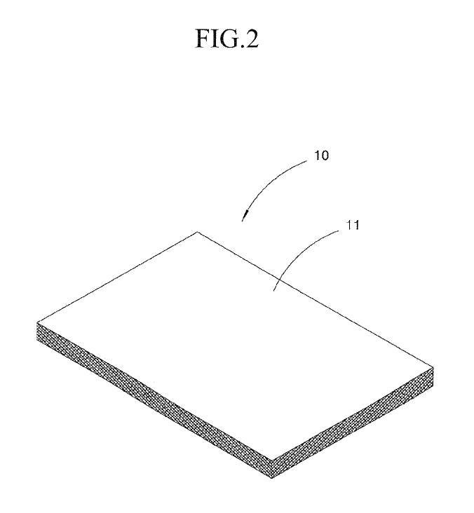

In the embodiment of the present invention, as shown in FIG. 2, it is appreciated that a protection sheet 11 is attached at both sides of a metallic mat 10, thus preventing the inputs of foreign substances into the interior of a metallic cotton ball.

It is preferred that the protection sheet 11 is made from one among a metallic, thin sheet, an inflammable paper sheet and an inflammable woven cloth.

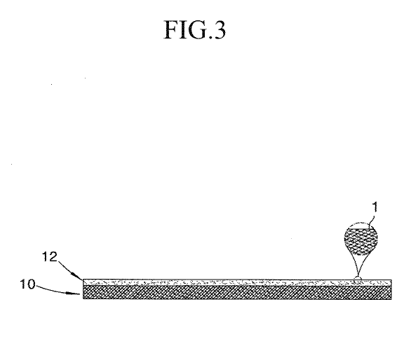

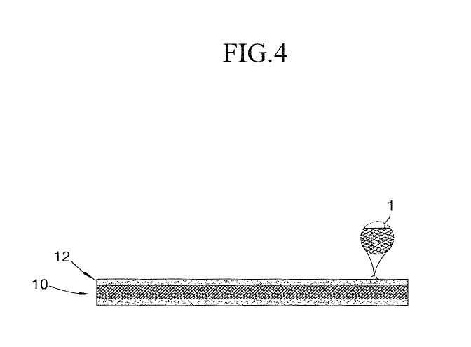

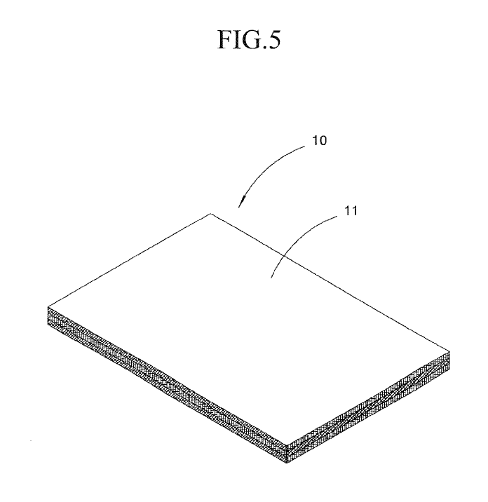

In the embodiment of the present invention, as shown in FIGS. 3 and 4, a hardening finishing agent is coated on at least one surface of the metallic mat 10, with the hardening finishing agent being made in such a way that a metallic thread is cut a certain length and impregnated and mixed with one hardening finishing paste selected among a hardening resin such as an urea resin and an epoxy resin and a hardening gypsum agent such as a cement and a gypsum, thus enhancing a durable hardening finishing layer 12.

It is appreciated that the metallic mat 10 might be formed in a double layer structure or preferably more structures with the aid of engaging members at least at two portions.

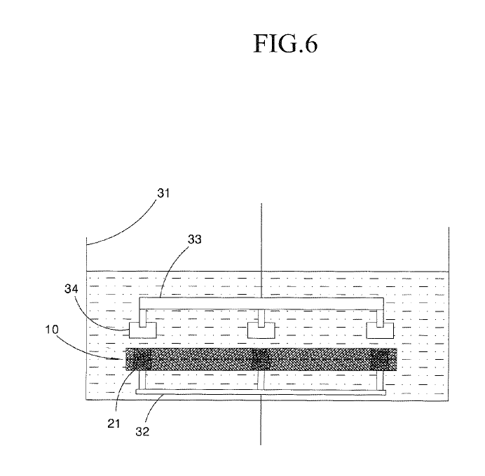

As shown in FIGS. 6 to 8, the engaging member might be a plated engaging part 21 in which a metallic thread is interconnected by means of a plating material in a plating method. The metallic mat is submerged in water in the plating bathtub 31, and the (−) electrode 33 is made to come into contact with the engaging portion, and the (+) electrode 32 engaged with the plating metal 34 is made to come close to the opposite side of the (−) electrode 33, thus forming a plating engaging part 21 at the engaging part through a concentrated plating.

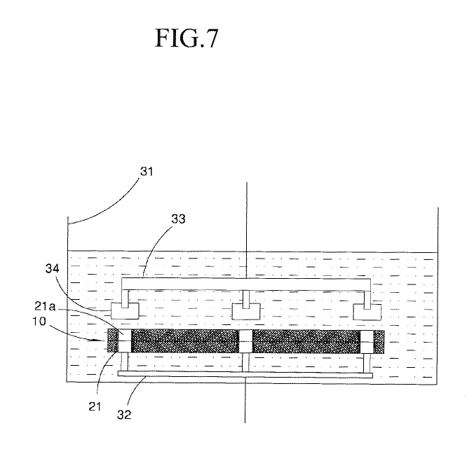

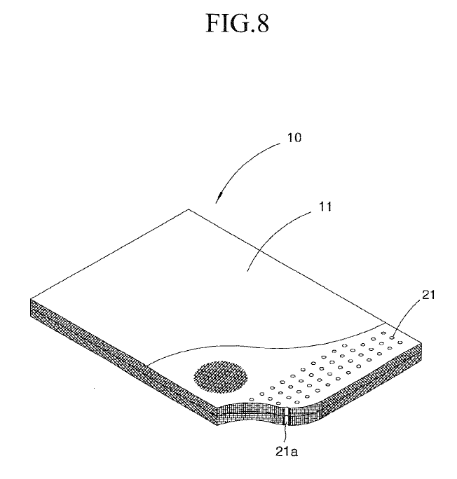

For a reliable, concentrated engaging work by means of the plating engaging part 21, as shown in FIGS. 7 and 8, a plating hole 21a is formed at the plating engaging part 21 of the metallic mat 10, passing through the same. The plating engaging part 21 is formed at an inner wall of the plating hole 21a.

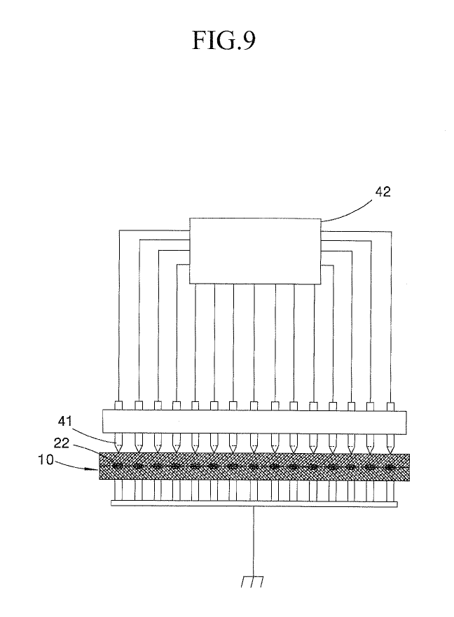

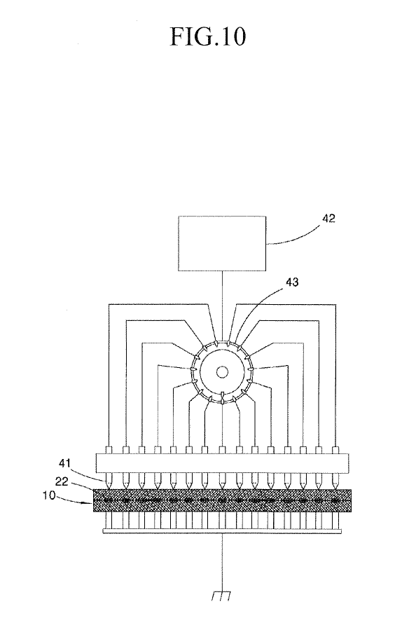

According to another example of the engaging member, as shown in FIGS. 9 and 10, a spot welding engaging part 22 can be formed so that the facing metallic threads are combined by a stop welding method. As shown in FIG. 10, there are provided a plurality of welding ports 41, a welding power supplier 42 for supplying a high voltage power for the spot welding, and a rotary distributor 43 for sequentially distributing the electric power so as to prevent overload of the welding electric power supplier 42 owing to the concurrent power supply to the plurality of the welding ports 41, so welding works are sequentially performed.

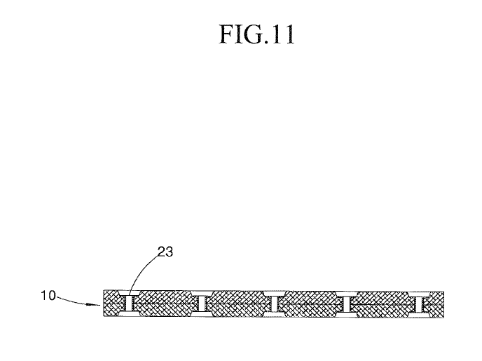

According to another example of the engaging member, as shown in FIG. 11, a rivet engaging part 23 might be implemented, in which engagement is performed with the aid of rivets. It is preferred that the rivets of the rivet engaging part 23 are eye rivets with each of its center being passed though.

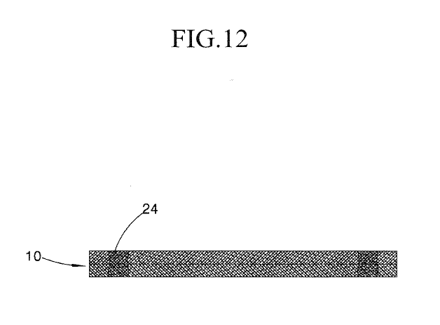

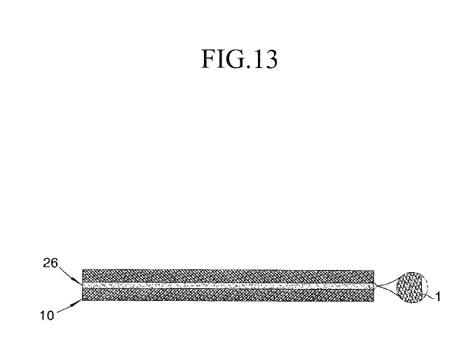

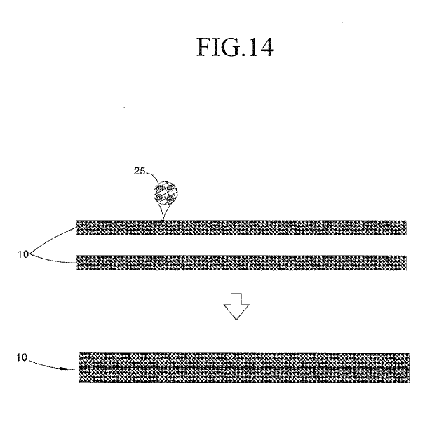

According to another example of the engaging member, as shown in FIGS. 12 and 13, a hardening adhesive engaging part 24 might be formed of one hardening adhesive agent selected among a hardening resin adhesive agent such as an urea resin and an epoxy resin and a hardening gypsum adhesive agent such as a cement and a gypsum.

The hardening adhesive engaging part 24, as shown in FIG. 12, might be implemented by partially inserting a hardening adhesive agent into the metallic mat 10 or as shown in FIG. 13, a circular diameter hardening adhesive agent 25 made from a circular diameter hardening adhesive agent is impregnated during the manufacture of the metallic mat 10 and is pressed by a press machine, and the metallic thread of the metallic mat 10 to which the impregnated circular diameter hardening adhesive agent 25 is engaged is tangled with the circular diameter hardening adhesive agent 25.

According to another example of the engaging member, it might be tangled with a single metallic thread hardening adhesive agent 26 manufactured in such a manner that a metallic thread is cut and impregnated and mixed with one hardening adhesive paste selected among a hardening resin agent such as an urea resin and an epoxy resin and a hardening gypsum agent such as a cement and a gypsum.

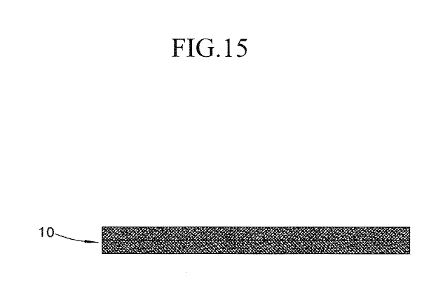

As shown in FIG. 15, the metallic mat might be manufactured in such a way to combine and impregnate together a metallic thread and a hardening adhesive agent. In a double layer structure, the engagement can be down through the entire portions with resin. The adhesive agent can be injected with the aid of pressure from the lower side of the metallic mat 10 or alternatively, the metallic mat 10 can be inputted into a container filled with a hardening adhesive agent.

The operations of the present invention will be described.

As described above, in terms of the inflammable mat board for architecture according to the present invention, a metallic thread made in a thin shape from a metallic material such as an iron, a nonferrous metal or the like is tangled like a cotton ball, thus manufacturing a metallic mat 10. The inflammable mat board for architecture according to the present invention can be well applied to an interior material like a partition wall or the like or can be engaged into the interior of an exterior material like a soundproof wall, thus efficiently maintaining a soundproof function, a heat insulation function and an inflammable function.

The present invention uses a metallic wire, so an applicable range of material is very wide, and in case of a demolishment of buildings, a lot of wastes can be recycled without leaving any wastes behind.

Since the inflammable mat board for an architecture according to the present invention is made from a metallic material, it cannot be easily cut, and an intruder cannot easily break the inflammable mat board for an architecture for trespassing.

In the present invention, when a bigger porous is adapted without using a protection sheet, the inflammable mat board for an architecture according to the present invention can be used as a core material enhancing a strength of a concrete cast material of a building.

In the preferred embodiment of the present invention, the inflammable mat board for an architecture can be used as a finishing material at a partition wall when a hardening finishing layer 12 is formed at a metallic mat 10.

Accordingly, the inflammable mat board for an architecture according to the present invention is made from a metallic thread, a recycling is promoted, and an inflammability, soundproof performance and heat insulation effect can be maximized.

In addition, it is appreciated that a recycling rate of materials produced in the course of a demolition of a building can be enhanced, and the producing amount of wastes can be minimized, which consequently contributes to a green industry growth throughout the world.

1. An inflammable mat board for an architecture, comprising:
a metallic mat which is manufactured in such a way that a metallic thread made from a certain metal in a thin shape is tangled like a cotton ball.

2. An inflammable mat board for an architecture according to claim 1, wherein said metallic thread has a thickness of 1˜0.1 mm in such a way to have a lightness and a good heat insulation function, with an anticorrosion agent such as a zinc, an urea resin, an epoxy resin, a cement and a gypsum being coated on an outer surface of the metallic thread, with said coating of the anticorrosion agent being performed on an outer surface of the metallic thread or said coating of the same being performed after an anticorrosion agent being coated after a metallic mat is formed of a metallic thread, so the metallic thread belong to the metallic mat is inter-tangled along with an anticorrosion agent, thus obtaining a certain durability.

3. An inflammable mat board for an architecture according to claim 1, wherein a protection sheet, which is made from one among a metallic, thin sheet, an inflammable paper sheet, and an inflammable woven sheet, is attached to both sides of a metallic mat in such a way to prevent the invasion of foreign substances, and a hardening finishing layer is formed in such a way that a hardening finishing agent is coated on at least one surface of the metallic mat, with said hardening finishing agent being made by cutting a metallic thread with a certain length and impregnating and mixing with one hardening finishing agent paste between a hardening resin agent such as an urea resin and an epoxy resin and a hardening gypsum agent such as a cement and a gypsum, thus enhancing durability.

4. An inflammable mat board for an architecture according to claim 1, wherein said metallic mat is formed in a double layer structure with the aid of an engaging means at least at two portions, said engaging means being implemented with the aid of one way selected from the group comprising:
an engaging way that a plating engaging part is formed in such a way that metallic threads are connected with each other by means of a plating material through a plating work;
an engaging way that a spot welding engaging part is formed in such a way that facing metallic threads are engaged by means of a spot welding;
an engaging way that a rivet engaging part is formed, thus engaging by means of rivets;
an engaging way that a hardening adhesive agent engaging part is formed by one hardening adhesive agent such as a hardening resin like an urea resin and an epoxy resin and a hardening gypsum agent like a cement and a gypsum;
an engaging way that a hardening adhesive agent engaging part is formed in such a way that a circular diameter hardening agent made by forming in a circular shape one hardening adhesive agent between a hardening resin such as an urea resin and an epoxy resin and a hardening gypsum adhesive agent is impregnated into a metallic mat, and is engaged with a metallic tread of a metallic mat to which a circular diameter hardening adhesive agent is engaged by pressurizing the metallic mat with a press machine; and
an engaging way that a single metallic thread mixing hardening adhesive agent which is formed in such a way that a metallic thread is cut with a certain length and is impregnated and mixed with one hardening adhesive paste between a hardening resin such as an urea resin and an epoxy resin and a hardening gypsum agent such as a cement and a gypsum.

5. A method for manufacturing an inflammable mat board for an architecture, comprising:
a step for forming a metallic mat in such a way that a metallic thread made with a thickness of 1˜0.1 mm by using a metallic material is tangled with each other like a cotton ball, and
said metallic mat is engaged by means of a plating engaging part so that a metallic thread is engaged by means of a plating at least at two portions, and said metallic mat is submerge in a plating bathtub, and a (−) electrode comes into contact with an engaging portion, and a (+) electrode engaged with a plating meta comes closer to the opposite side of the (−) electrode, thus concentrating a plating at an engaged portion.

6. A method for manufacturing an inflammable mat board for an architecture, comprising:
a step for forming a metallic mat in such a way that a metallic thread made with a thickness of 1˜0.1 mm by using a metallic material is tangled with each other like a cotton ball, and
said metallic mat includes:
a plurality of welding ports in which opposite metallic wires are engaged by means of a spot welding engaging part at least at two portions by a spot welding method; and
a welding electric power supplier which serves to supply a high electric power for a spot welding.

7. A method for manufacturing an inflammable mat board for an architecture according to claim 6, wherein a rotary distributor is provided for sequentially distributing an electric power so as to prevent an over load of the welding electric power supplier which overload occurs since an electric power is concurrently supplied to a plurality of the welding ports.

8. A method for manufacturing an inflammable mat board for an architecture, comprising:
a step for forming a metallic mat in such a way that a metallic thread made with a thickness of 1˜0.1 mm by using a metallic material is tangled with each other like a cotton ball, and
said metallic mat is engaged by means of a rivet engaging part a least at two portions by using rivets.

9. A method for manufacturing an inflammable mat board for an architecture, comprising:
a step for forming a metallic mat in such a way that a metallic thread made with a thickness of 1˜0.1 mm by using a metallic material is tangled with each other like a cotton ball, said metallic thread tangling procedure being implemented with the aid of one selected from the group comprising:
an engaging way that an engaging work is implemented by one hardening adhesive agent such as a hardening resin like an urea resin and an epoxy resin and a hardening gypsum agent like a cement and a gypsum;
an engaging way that a circular hardening adhesive agent made by forming is a circular shape a hardening resin such as an urea resin and an epoxy resin and a hardening gypsum agent such as a cement and a gypsum is impregnated into a metallic mat, and the metallic mat is pressurized by a press machine; and
an engaging way that a single metallic thread mixing hardening adhesive agent is formed in such a way that a metallic thread is cut with a certain length and is impregnated into and mixed with one hardening adhesive paste between a hardening resin agent such as an urea resin and an epoxy resin and a hardening gypsum agent such as a cement and a gypsum.

10. A method for manufacturing an inflammable mat board for an architecture according to claim 9, wherein a metallic mat is made in such a way to mix together a metallic thread with one hardening adhesive agent such as a hardening resin such as an urea resin and an epoxy resin and a hardening gypsum adhesive agent such as a cement and a gypsum.

11. A method for manufacturing an inflammable mat board for an architecture according to claim 10, wherein a protection sheet, which is made from one among a metallic, thin sheet, an inflammable paper sheet, and an inflammable woven sheet, is attached to both sides of a metallic mat in such a way to prevent the invasion of foreign substances, and a hardening finishing layer is formed in such a way that a hardening finishing agent is coated on at least one surface of the metallic mat, with said hardening finishing agent being made by cutting a metallic thread with a certain length and impregnating and mixing with one hardening finishing agent paste between a hardening resin agent such as an urea resin and an epoxy resin and a hardening gypsum agent such as a cement and a to gypsum, thus enhancing durability.
